(19) United States
(12) Patent Application Publication
(10) Pub. No.: US 2023/0088930 A1
(43) Pub. Date: Mar. 23, 2023

(54) AIRBORNE RADAR AND 5G RADIO FREQUENCY SPECTRUM SHARING

(71) Applicant: A10 Systems LLC, Chelmsford, MA (US)

(72) Inventors: Apurva N. Mody, Chelmsford, MA (US); James Dolan, Frederick, MD (US); David Simpson, Springfield, VA (US)

(21) Appl. No.: 17/933,368

(22) Filed: Sep. 19, 2022

Related U.S. Application Data
(60) Provisional application No. 63/245,555, filed on Sep. 17, 2021.

(51) Int. Cl. H04W 16/14; H04B 17/336

(52) U.S. Cl. CPC H04W 16/14; H04B 17/336; H04W 84/06

(57) ABSTRACT

According to aspects of this disclosure, systems and methods for spectrum sharing comprising is presented. The system comprises at least one controller configured to receive first data pertaining to a first system, and send to and receive second data from a second system, the first system and second system configured to use at least part of the same spectrum, the at least one controller being further configured to based at least in part on the first data, determine that the first system is using at least part of the same spectrum based at least in part of the second data, determine that the first system is likely to be interfered with by the second system, and provide instructions instructing the second system to modify one or more operational parameters of the second system to reduce interference with the first system.

### CROSS-REFERENCE TO RELATED APPLICATIONS

This application claims priority under 35 U.S.C. § 119(e) to U.S. Provisional Application Ser. No. 63/245,555, titled “Airborne Radar and 5G Radio Frequency Spectrum Sharing,” filed on Sep. 17, 2021, which is hereby incorporated by reference in its entirety.

### BACKGROUND

Fifth generation wireless communication technologies (5G technologies) may provide substantially improved connectivity, speed, and responsiveness compared to existing wireless communication technologies, such as 4G long-term evolution (LTE) communication systems.

5G technologies, like other wireless communication technologies, use the radio frequency (RF) spectrum. Many 5G communications fall within the approximately 1 to 6 GHz band (the FR1 band), while some other 5G communications operate at frequencies higher than 6 GHz (the FR2 band). Both FR1 and FR2 bands include frequencies that are utilized by the United States Department of Defense (DoD) for shipborne and airborne radio detection and ranging systems (radar). The addition of RF signals originating from 5G base stations (e.g., cell-phone towers and/or other transmit/receive/relay structures) and user devices (e.g., cell-phones and other wireless communication devices) may raise the noise floor in the FR1 and/or FR2 band and thus may create interference for sensitive radar systems, such as airborne systems including those mounted on the Airborne Warning and Control System (AWACS) platform, ground-based radars, and shipborne radars such as SPY-1 and SPN-43.

### SUMMARY

According to at least one aspect of the present disclosure, there is presented a system for spectrum sharing. In some examples, the system of spectrum sharing comprises at least one controller configured to receive first data pertaining to a first system, and send to and receive second data from a second system, the first system and second system configured to use at least part of the same spectrum, the at least one controller being further configured to based at least in part on the first data, determine that the first system is using at least part of the same spectrum, based at least in part of the second data, determine that the first system is likely to be interfered with by the second system, and provide instructions instructing the second system to modify one or more operational parameters of the second system to reduce interference with the first system.

In some examples, the first system is a radar and the second system is a 5G network. In various examples, the first data is reference signal data and the second data is network data. In many examples, the system further comprises a sharing and coexistence system configured to detect the presence of the first system and to provide the first data to the at least one controller. In some examples, the system further comprises a cross layer sensing block communicatively coupled to the second system and the sharing and coexistence system and configured to generate one or more decisions, a decision engine communicatively coupled to the cross layer sensing block and the second system and configured to determine one or more operational parameters, and a performance database communicatively coupled to the decision engine and configured to provide performance curves to the decision engine. In some examples, the cross layer sensing block further comprises a feature extraction and normalization block communicatively coupled to an environmental characterization and pattern classification block, the feature extraction and normalization block being configured to process data received from the cross layer sensing block, and the environmental characterization and pattern classification block being configured to generate the one or more decisions, and the decision engine further comprises an edge compute decision engine configured to determine the operational parameters and a policy engine configured to provide policies to the edge compute decision engine.

In some examples, the policy engine further comprises a dynamic games module. In many examples, the cross layer sensing block is further configured to process the first data and the second data. In various examples, the cross layer sensing block is further configured to generate the one or more decisions responsive to processing the second data. In many examples, the one or more decisions include a probability that the first system is present. In some examples, the one or more decisions are determined using a partially observable Markov decision process. In many examples, the one or more decisions are determined based on at least one of a pulse repetition interval, a pulse width, and a modulation on a pulse of a signal originating from the first system. In various examples, the one or more decisions include an estimate of at least one base station or user device which is likely to cause interference with the first system. In some examples, the cross layer sensing block is further configured to provide the one or more decisions to the decision engine, and the decision engine is further configured to determine the one or more operational parameters for the second system based on the one or more decisions to mitigate interference of the second system with the first system. In various examples, the decision engine is further configured to determine the one or more operational parameters based on one or more policies. In many examples, the performance database is further configured to provide one or more performance curves based on Swerling models to the decision engine, and the decision engine is configured to use the one or more performance curves to determine the one or more operational parameters.

In some examples, the first data is provided by an incumbent informing capability. In various examples, the incumbent informing capability provides information to the at least one controller indicating that the first system is present. In many examples, determining that the radar is present includes the at least one controller being configured to calculate a probability that the radar is present based at least in part on the spectrum data, and the at least one controller being configured to determine that the probability that the radar is present is greater than a threshold value. In various examples, the first data includes location data indicative of a location of the first system and/or includes the channel data including information indicating which channels may cause interference and/or which channels are available for use. In some examples, the at least one controller determines if the first system is likely present based on one or more reference signals of the second system. In various examples, the at least one controller determines that the radar is likely present based on at least one of an uplink demodulation reference signal, an uplink sounding reference signal, a primary synchronization signal, and a secondary synchronization signal. In many examples, one or more user devices of the second system provide one or more channel quality indications to a base station of the second system which determines that the first system is present.

In some examples, determining that the first system is likely to be interfered with includes the at least one controller calculating a probability that a noise floor of the first system exceeds a threshold noise value, the probability being based on the second data. In many examples, calculating the probability that a noise floor of the first system exceeds the threshold noise value includes determining one or more of a desired probability of false alarms, a desired probability of detection, a target detection range, and SNR at the first system. In various examples, the second data includes one or more of an indication of the physical location of one or more base stations, orientation of one or more base stations, transmit power of one or more base stations or user devices, angle of beams, user device locations, and radio performance measurements. In some examples, the radio performance measurements include one or more of received signal strength indicator data, reference signal received power data, carrier-to-interference plus noise ratio data, Signal to Interference plus Noise Ratio data, error vector magnitude data, bit error rate data, packet error rate data, channel quality indicator data, modulation settings, and coding settings. In many examples, the at least one controller determines how to modify the operational parameters of the second system based on one or more mitigation techniques. In various examples, the one or more mitigation techniques includes resource block sharing.

In some examples, the at least one controller may instruct a base station of the second system to allocate resource blocks to be used by the first system, and other resource blocks to be used for the second system. In various examples, the mitigation techniques include at least one of channel assignment, carrier aggregation, resource block sharing, transit power control, beamforming, adaptive modulation and coding, interference aware routing, and handover. In various examples, some elements of the at least one controller are implemented as an agent residing on a user device of the second system as an application. In some examples, the agent makes a decision on what mode of transport should be used to avoid interference with the first system. In many examples, the at least one controller instructs all the user devices to use Wi-Fi or satellite communications capability responsive to determining that the first system is using a same channel as the second system. In various examples, the at least one controller may instruct a base station of the second system to reduce power and/or disable transmission in certain directions. In some examples, the agent, responsive to the base station reducing power, may instruct each user device communicatively coupled to the base station reducing power to connect with a base station not reducing power. In many examples, responsive to determining that the first system is using a same channel as the second system on a first frequency band, the agent forwards all traffic on the second system originating from the user device to a second frequency band.

In some examples, responsive to determining that the first system is using a same channel as the second system, the agent forwards all traffic on the second system originating from the user device to a Wi-Fi or satellite communications network. In many examples, responsive to determining that the first system is using a same channel as the second system, the at least one controller instructs the agent to forward all traffic on the second system to a Wi-Fi or satellite communications network. In various examples, the at least one controller resides on a multi-access edge compute node.

According to aspects of the disclosure, there is presented a non-transitory computer-readable medium containing thereon instructions instructing at least one processor to, based at least in part on first data pertaining to a first system, determine that the first system is present, based at least in part on second data originating from a second system, determine that the first system is likely to be interfered with by signals originating from the second system, and provide instructions instructing the second system to modify operational parameters of the second system to avoid interference with the first system.

In some examples, the instructions further instructing the at least one processor to calculate a probability that the first system is present based at least in part on the first data, and determine that the probability is greater than a threshold value. I many examples, the first data includes location data indicative of a location of the first system and/or channel data indicative of which channels are impacting the first system and/or which are available for use by the first system. In various examples, the instructions further instruct the at least one processor to calculate the probability that the first system is present by using, at least in part, a partially observable Markov decision process. In many examples, the instruction further instruct the at least one processor to calculate a probability that the noise floor of the first system exceeds a threshold noise value, the probability being based at least in part on the second data, wherein the probability exceeding the threshold noise value indicates that the first system is likely to be interfered with by the second system. In some examples, the second data includes one or more of an indication of the physical location of a base station of the first system and radio performance measurements. In many examples, the instruction further instruct the at least one processor to model the second system's interference with the first system using Swerling Models that define the first system's performance. In various examples, calculating that the noise floor of the first system exceeds the threshold noise value includes the instructions instructing the at least one processor to determine one or more of a probability of false alarms, a probability of detection, and a target detection range. In many examples, the instructions further instruct the at least one processor to formulate the instructions provided to the second system by using dynamic games. In some examples, the first system is a radar and the second system is a 5G network. In various examples, the first data is reference signal data and the second data is network data.

According to aspects of the disclosure, there is presented a method for managing signal interference comprising receiving first data pertaining to a first system, receiving second data from a second system, determining that the first system is present based at least in part on the first data, determining that the first system is likely to be interfered with by signals originating from the second system, responsive to determining that the first system is likely to be interfered with by signals originating from the second system, generating instructions instructing the second system to modify its operational parameters to reduce interference with the first system, and providing the instructions to the second system.

In some examples, the method further comprises calculating a probability that the first system is present based at least in part on the first data and, responsive to calculating the probability that the first system is present, determining that the probability that the first system is present is greater than a threshold value, and calculating a probability that a noise floor of the first system exceeds a threshold noise value, the probability that the noise floor exceeds the threshold noise value being based at least in part of the second data. In various examples, the first system is a radar and the second system if a 5G network, and the first data is reference signal data and the second data is network data.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A illustrates block diagram of a spectrum sharing system according to an example;

FIG. 1B illustrates a block diagram of a spectrum sharing system according to an example;

FIG. 2 illustrates a block diagram of a controller according to an example;

FIG. 3 illustrates a block diagram of a controller according to an example;

FIG. 4 illustrates a flowchart of a process according to an example;

FIG. 5 illustrates a block diagram of logical or functional relationships according to an example;

FIG. 6 illustrates a block diagram of a 5G network according to an example;

FIG. 7A illustrates a diagram of resource sharing of a 4G/5G system according to an example;

FIG. 7B illustrates a diagram of resource sharing of a 4G/5G system according to an example; and

FIG. 8 illustrates a communications system architecture according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Spectrum sharing may be a way to optimize the use of the airwaves, or wireless communications channels, by enabling multiple categories of users to safely share the same frequency bands. Network Sharing may enable partitioning of the network such that multiple entities may use portions of the network to meet their individual needs. Network Function Virtualization (NFV) and Network Slicing are some ways to perform Network Sharing.

For examples, AWACS radar systems are extremely sensitive, being designed to detect aircraft, ships, and vehicles at extremely long ranges (200 km and more), and to distinguish between friendly and hostile targets. AWACS radar systems have sensitive receivers with high gain. The high gain helps the AWACS radar system to detect weak backscatter from targets. Energy directed into the AWACS radar may interfere with the receiver. For example, energy from 5G base stations and user devices may desensitize the AWACS radar system and interfere with detection, or backscatter from targets may be lost in the noise generated by the transmissions from the 5G base stations and user devices. In some examples, spectrum sharing between the 5G network and the AWACS radar system may reduce interference with detection, and may reduce noise.

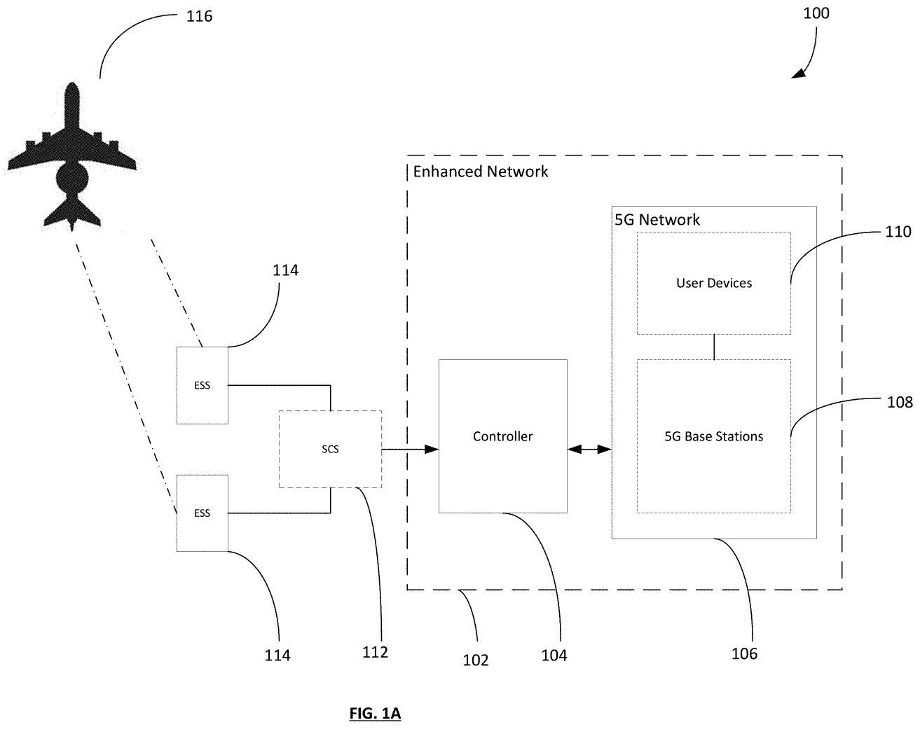

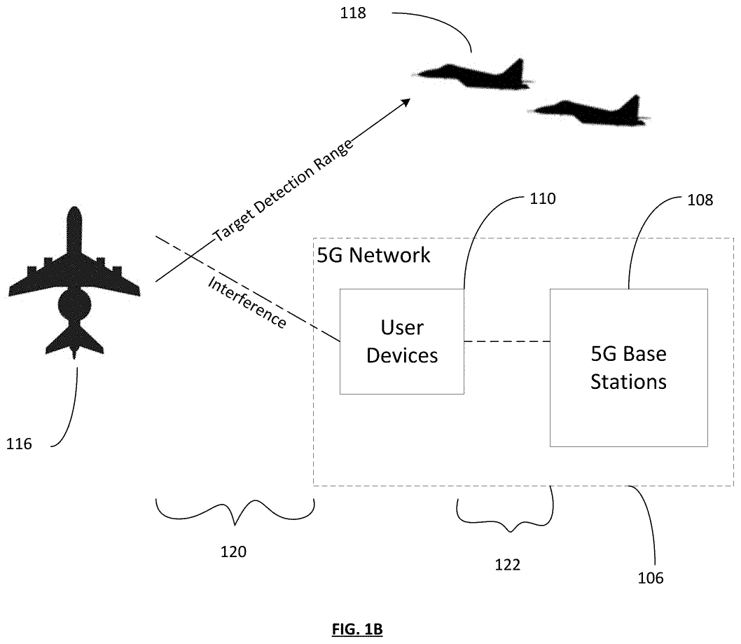

FIG. 1A illustrates a Spectrum Sharing (SS) system 100 according to an example. The SS system 100 includes an enhanced network 102, a controller 104, a 5G network 106, a 5G base station (base station) 108, one or more User Equipment (UE) 110, a sharing and coexistence system (SCS) 112 (the SCS may sometimes be referred to as a spectrum coordination system or an incumbent informing capability), one or more Environmental Sensing Capability (ESC) system 114, and an airborne radar system 116. ESC and environmental sensing system may be used interchangeably in some examples. User Equipment and User Devices may also be interchangeably in some examples. In some examples, ESC, ESS, RF sensing and/or wideband sensing may be used interchangeably.

The airborne radar system 116 may be any type of airborne radar system, for example, AWACS. The airborne radar system 116 transmits and receives RF signals (shown by the dotted line). The airborne radar system 116 may transmit and receive RF signals corresponding to a particular frequency band or range, for example, FR1.

The environmental sensing system 114 may detect signals transmitted by the airborne radar system 116 and/or may collect other data. In some examples, the environmental sensing system 114 may calculate the location of the airborne radar system 116, using any appropriate method such as Time Difference of Arrival (TDoA), Angle of Arrival (AoA) or some other interferometric technique. In various examples, the environmental sensing system 114 will be prohibited from determining the location of the airborne radar system 116, for example, due to operational security concerns, and will instead sense the RF spectrum. The environmental sensing system 114 may then provide the RF spectrum data it collects to the SCS 112.

The SCS 112 may be configured to detect the presence of radar signals, such as those from the airborne radar system 116, and can provide the RF spectrum data and any information indicative of the presence of a radar to the controller 104 of the enhanced network 102. For example, the SCS 112 may provide information indicative of a location and/or approximate location of the airborne radar system 116 and/or information indicative of the trajectory or approximate trajectory of the airborne radar system 116. The SCS 112 may also receive other data from the environmental sensing system 114 or directly collect data. For example, either the environmental sensing system 114 or the SCS 112 may collect data relating to the absence or presence of the airborne radar system 116, the location of the airborne radar system 116, or information pertaining to which 5G channels are available for use.

On the “other end of the spectrum”—that is, within the 5G network 106, user devices 110 and base stations 108 may be communicatively coupled together, and may be transmitting and receiving radio signals in various RF bands (e.g., within the FR1 band). The signals transmitted by the base stations 108 and user devices 110 may create interference, that is, noise, in the RF bands used by the airborne radar system 116. In some cases, the base stations 108 and user devices 110 may generate noise by transmitting at a given power level typically less than the power level of the transmissions of the airborne radar system 116. In some examples, the aggregate effect of multiple base stations 108 and/or user devices 110 transmitting will create sufficient amounts of noise to raise the noise floor of the relevant RF bands. The 5G network 106 may have access to information regarding the transmissions, performance, locations, and other attributes of the user devices 110 and base stations 108. For example, the 5G network 106 may have access to information pertaining to the physical layer (PHY), network layer (NET), and/or medium access control (MAC) layer, as well as information pertaining to other 5G RF-related functionalities. Such additional 5G RF-related functionalities may include received signal strength indicator (RSSI) information, reference signal received power (RSRP), carrier-to-interference plus noise ratio (CINR)/Signal to Interference plus Noise Ratio (SINR) data, error vector magnitude (EVM) data, bit error rate (BER) data, packet error rate (PER) data, channel quality indicator (CQI), modulation settings, coding settings, and so forth. The 5G network 106 may provide the information available to it, including the forgoing data, to the controller 104. Data available to the 5G network may be referred to as 5G network data or network data. It will be appreciated that the controller 104 may receive information available to the 5G network 106 directly from the user devices 110, base stations 108, and/or any other part of the 5G network.

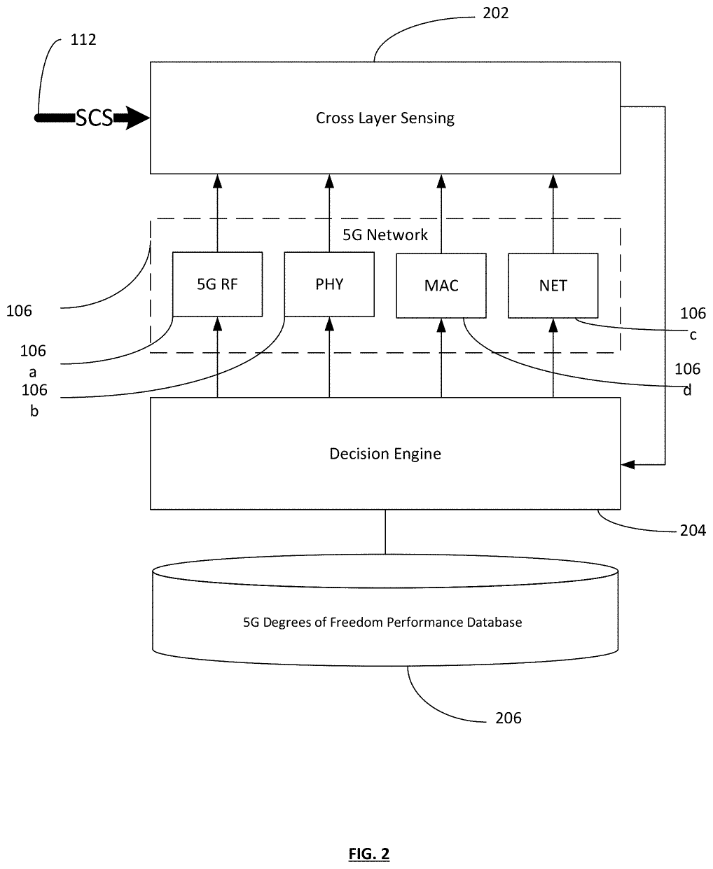

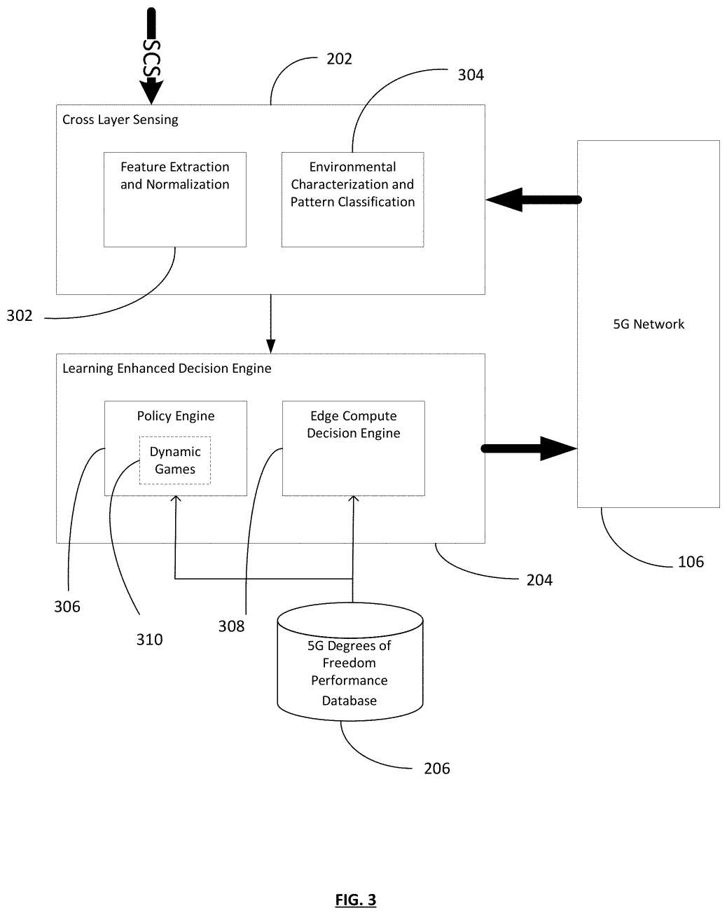

The controller 104 may receive information from the SCS 112 and 5G network 106. The controller 104 may analyze the data received from the SCS 112 to determine if a radar system, for example the airborne radar system 116, is present and/or active in a given area. The controller 104 may also analyze the data received from the 5G network 106 to determine the 5G network's 106 operational parameters and/or state. The controller 104 may analyze the data provided to it to determine adjustments to the operational parameters and/or state of the 5G network 106 which would minimize or eliminate interference by the 5G network 106 with the airborne radar system 116. The controller 104 will be discussed in greater detail with respect to FIGS. 2 and 3, and elsewhere herein.

It will be appreciated that there may be multiple 5G base stations 108 and multiple airborne radar systems 116. There may also be multiple SCS 112, controllers 104, and so forth, and any component of the SS system 100 may be distributed and/or decentralized.

FIG. 1B illustrates aspects of the SS system 100 according to an example. The airborne radar system 116 may attempt to detect various targets 118. The targets 118 may be anything detectable by radar, for example, warfighters. The user devices 110 and base station 108 of the 5G network communicate with one another, and may generate interference with the airborne radar system 116. For example, pencil beam transmissions from the user devices 110 may desensitize or otherwise interfere with the airborne radar system 116. In some examples, the interference will be a physical medium such as a frequency or optical wavelengths. The user devices 110 and base stations 108 may be a given distance from each other. The distance at which the user devices 110 and base stations may communicate can be referred to as the comms range 122. In some examples, the comms range 122 is the maximum distance at which communication is possible between any two antennas in the 5G network 106. The distance between elements of the 5G network 106 and the airborne radar system 116 may be referred to as the standoff range 120. If the airborne radar system is closer than the standoff range reduction to the 5G network 106, that is, if the standoff range 120 is too small, the 5G network may interfere with the airborne radar system 116. In some examples, the airborne radar system 116 may not be able to detect targets 118, or the distance at which the airborne radar system 116 can detect targets 118, called the target detection range, may be reduced. In some examples, the target detection range may be a distance at which the radar is able to detect a target with a high probability of detection and a low probability of false alarm. By managing the interference between the airborne radar system 116 and the 5G network 106, for example by using the SS system 100 or the controller 104, the effects of interference can be minimized. For example, the standoff range 120 can be minimized or reduced while the target detection range is not adversely affected, or is only slightly affected compared to an unmanaged system.

FIG. 2 illustrates an example of the controller 104 within the context of the SS system 100 according to an example.

The controller 104 includes a cross layer sensing block (CLS) 202, a decision engine (decision engine) 204, and a 5G degrees of freedom performance database (database or 5GPD) 206. The CLS 202 receives information from the SCS 112 and the 5G Network 106, including any of the data mentioned with respect to FIG. 1. For example, the SCS 112 may provide data pertaining to the absence or presence of radar, location of the radar source, and 5G channel availability to the CLS 202. The 5G network 106 may provide any of the data available to it, for example 5G RF data (and/or modulation and coding data) 106a, physical layer data 106b, MAC layer data 106c, and/or network layer data 106d, to the CLS 202.

The CLS 202 may parse, normalize, and convert the information it receives to soft decision information used to guide optimization functions of the decision engine 204. The CLS 202 will be discussed in greater detail with respect to FIGS. 2-5, and elsewhere herein. The CLS 202 may provide the parsed and normalized data and/or soft decision information to the decision engine 204.

The decision engine 204 may use machine learning techniques to model the operation of the 5G network 106, the characteristics of the 5G network's 106 footprint (i.e., the 5G network's 106 effect on various RF bands, such as FR1), and any other attributes of the 5G network 106. The decision engine 204 generates new operational parameters for the 5G network 106, the new parameters being configured to minimize interference between the 5G network 106 and the airborne radar system 116. The decision engine 204 may then provide instructions to the 5G network 106 instructing the 5G network 106 to alter its operational parameters in accordance with the decision engine's 204 newly generated parameters. For example, the decision engine 204 may instruct the 5G network 106 to modify any of the 5G RF 106a operational parameters and/or the physical layer 106b, MAC layer 106c, and/or network layer operational parameters, and any other operational parameters of the 5G network 106.

The decision engine 204 may use the information provided by the CLS 202 and any information stored within the database 206 as inputs to its machine learning models, and/or may use the information stored within the database 206 to form the machine learning models. The decision engine 204 will be discussed in greater detail with respect to FIG. 2-5, and elsewhere herein.

The database 206 includes models of strategies and techniques used to control the RF footprint and/or characteristics of the 5G network 106, as well as data about how much interference the 5G network 106 may cause to the airborne radar system 116. For example, the database 206 may be able to provide information about the amount of interference the 5G network 106 will cause to the airborne radar system 116 given certain operational parameters, location data, and/or available channels. The models stored in the database 206 may be performance curves or Swerling Models capable of evaluating the performance of the 5G network 106 and the 5G network's 106 interference with the airborne radar system 116. In some cases, the performance curves may be based on the Swerling Models. The 5G performance database contains various performance curves which may be based on Swerling Models. The DE interprets those curves based on information from the CLS and makes decisions.

FIG. 3 illustrates an embodiment of the controller 104 according to an example.

The CLS 202 includes a feature extraction and normalization block (feature extraction) block 302 and an environmental characterization and pattern classification (classification) block 304. The decision engine 204 includes a policy engine (PE) 306, edge compute decision engine (ECDE) 308, and a dynamic games module (310). The CLS 202, decision engine 204, and database 206 operate as described with respect to FIG. 2 and as further described below.

The feature extraction block 302 may gather information from the 5G network 106, including RF data, physical, MAC, and/or network layer data, RSSI, SINR, EVM, BER, PER, modulation and/or coding information, and/or other information available to the 5G network 106. The feature extraction block 302 may also parse data received from the SCS 112. The feature extraction block 302 may process the received data into a form useable by the classification block 304 and/or decision engine 204, and/or may normalize the received data. The feature extraction block 302 provides the parsed and normalized data received from the SCS 112 and the 5G network 106 to the classification block 304. The classification block 304 generates soft decisions. In some examples, the soft decisions may be expressed in terms of probabilities and probability distributions. In some examples, the classification block 304 may assign a probability indicative of confidence in the information received from the SCS 112, such as confidence in the presence or location of the airborne radar system 116, or in any other information received from the SCS 112. The soft decisions of the classification block 304 may be indicative of which user devices 110 and base stations 108 are most likely to interfere with the airborne radar system 116. The classification block 304 provides the soft decisions to the decision engine 204. In some examples, some or all of the information collected by the CLS 202 is provided to the decision engine 204 as soft decisions. In some examples, the soft decisions may include calculations reflecting a standoff range reduction between the airborne radar system 116 and the 5G network 106. Standoff range reduction is the range at which the 5G network 106 and airborne radar system 116 are able to coexist on the same spectrum band with no perceptible degradation to the airborne radar system 116 in terms of its performance compared to a baseline performance where there is no interference. Degradation of the airborne radar system 116 may be defined and expressed in terms of probability of false alarms, probability of detection, target detection range (for example, due to interference), and the signal to noise ratio (SNR). It will be appreciated that the probability of false alarm and probability of detection need not be set values. In some examples, the probability of false alarm and/or probability of detection may be set to a desired value or level.

It will be appreciated that, in some examples, the classification block 304 may use a partially observable Markov decision process to generate the soft decisions. The partially observable Markov decision process may, for example, be used to update the classification block's 304 belief in the true state of the SS system 100, such as the true presence or absence of a radar, or the true position or velocity of the radar, or the true state of the 5G network, and so forth. The partially observable Markov decision process does not require the classification block 304 (or indeed, any part of the SS system 100) to directly observe the SS system 100 state (or the state of any environment or part of the overall system or areas wherein the system is deployed, for example, the geographic region around a base station 108). In some examples, the CLS 202 may interact with and/or take measurements of environment and/or SS system 100 to update or improve the CLS's 202 belief in the true state of the system.

The decision engine 204 receives the soft decisions from the CLS 202 and uses them to learn and make decisions. In some examples, the decision engine 204 uses the soft decisions as priors. Priors may be, in some examples, a priori assumptions used as inputs to the decision-making process.

The decision engine 204 includes the DE 306, the dynamic games module 310, and the ECDE 308. The DE 306 may provide constraints (also referred to as policies, herein) to the ECDE 308 that drive the ECDE 308 to make correct decisions. The constraints may be anything, but in some examples will be related to maximizing performance and/or minimizing interference. In some examples, the constraints may be related to performance metrics, such as interference reduction ratio on the radar (IRRR), which is a measure of interference into the radar prior to mitigation by the controller 104 compared to after mitigation, interference reduction ratio on comms (IRRC), which is a measurement of interference with the user devices 110 prior to mitigation by the controller 104 compared to after mitigation, throughput reduction ratio (TRR), which is a measurement of spectrum available at given emission levels (frequency, power, and so forth), and may reflect comms throughput prior to mitigation by the controller 104 compared to after mitigation, target detection range reduction ratio (TDRR), which is a measure of the range at which the radar can detect target prior to mitigation by the controller 104 compared to after mitigation, and/or operational utility, which is a measure of the cost/difficulty of implementation, modifications, and security requirements with compared to without mitigation by the controller 104. For example, with respect to operational utility, it may be more expensive to provide in-radar mitigation of interference as opposed to adjusting the 5G network's 106 operational parameters. Constraints may seek to optimize (such as by maximizing or minimizing) any of the metrics listed above, or any combination of the metrics listed above.

In some examples, the DE 306 may use the of the dynamic games module 310 to formulate dynamic games based on the database 206 and the soft decisions provided by the CLS 202. The dynamic games of the dynamic games module 310 may be carried out using Swerling models. The results of the dynamic games may be used as the basis of and/or to create the constraints for the ECDE 308. In some examples, the DE 306 may generate one or more utility functions for the airborne radar system 116 and/or 5G network 106, and the utility functions may consider metrics like IRRR, IRRC, TRR, and TDRR, and may form or be part of the constraints. The utility functions may be used to model maximum performance of the SS system 100 under various conditions. The DE 306 may, in some examples, operate at a slower tempo compared to the ECDE 308. For example, the DE 306 may change its model at a slower pace or may require more time to complete calculations compared to the ECDE 308. In some examples, the DE 306 may use more complex algorithms and models compared to the ECDE 308, and the DE 306 may consider some or all available historical data (such as historical data relating to the 5G network 106 performance and/or airborne radar system 116 performance), possible modalities, and so forth.

In some examples, the CLS and DE components may be reside on a multi-access edge compute (MEC) node.

The decision engine 204 also includes the ECDE 308. The ECDE 308 may receive soft decisions from the CLS 202 and/or constraints from the DE 306, and may also access the models and data stored in the database 206. The ECDE 308 may make decisions concerning the operational parameters of the 5G network 106 based on the soft decision and/or constraints. For example, the ECDE 308 may determine which operational parameters need to be changed and how those operational parameters should be changed to minimize interference from the 5G network 106 with the airborne radar system 116. The ECDE 308 may select between multiple interference management strategies or combinations of strategies, including at least one or more of carrier aggregation and channel assignment (CA1), carrier aggregation (CA2), transit power control (TPC), beamforming and interference alignment (mMIMO-BM/IA/BM), adaptive modulation and coding (AMC), interference aware routing (IAR), handover (also referred to as handoff), resource block sharing (RBS), and so forth. Handover may, in some examples, include transferring a user device 110 from a first base station 108 to a second base station 108, for example, because the first base station 108 reduces the first base station's 108 output power level. The ECDE 308 may be driven by deep convolutional neural networks, deep reinforcement learning, and/or other machine learning techniques. The interference management strategies listed above may, in some cases, be referred to as mitigation techniques. Once the ECDE 308 has selected and appropriate strategy or combination of strategies, the ECDE 308 may provide instructions to the 5G network 106 instructing the 5G network 106 to alter operational parameters to conform with the ECDE's 308 strategy. Alternatively, in some examples, the ECDE 308 may directly control and set the operational parameters of the 5G network 106.

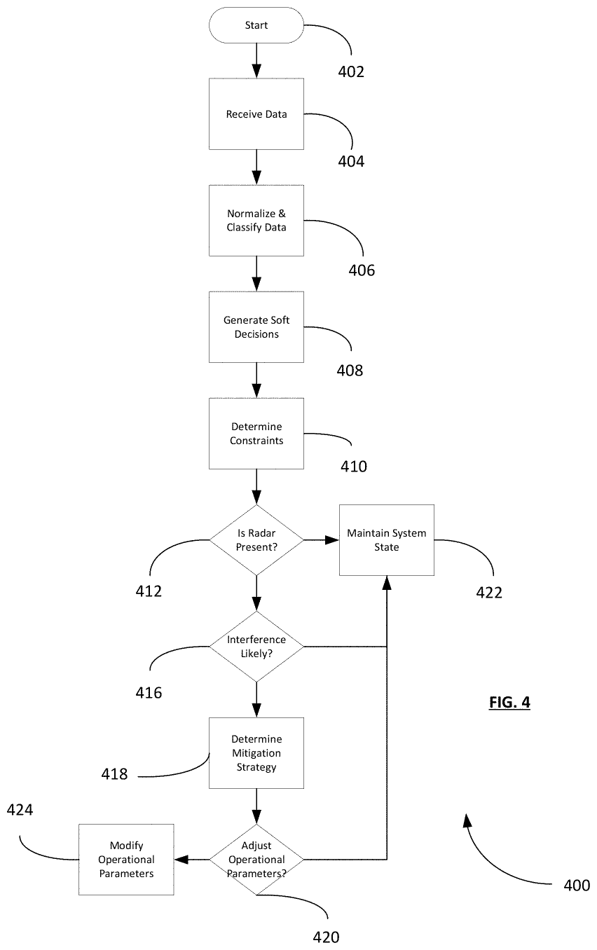

FIG. 4 illustrates a process 400 for mitigating interference with the airborne radar system 116. For example, the process 400 may be illustrative of the functions and/or acts performed by the SS system 100 or its individual components (e.g., the SCS 112, controller 104, 5G network 106, and so forth). For clarity, acts and elements of the process 400 will be discussed with respect to previously discussed element of the SS system 100.

At act 402, the process 400 may begin. In some examples, at act 402, the SS system 100 will already be in a given state. For example, the 5G network 106 may be configured such that its operational parameters and 5G RF related characteristics and functionalities are set to given values. In some examples, this may mean that the 5G network's 106 physical, network, or MAC layer, and/or RSSI, SINR, EVM, BER, PER, modulation settings, coding settings, channel information, and other operational parameters are set to a given value. Likewise, the airborne radar system 116 may have certain channel information, a trajectory, location, and other operational parameters set to a given value. It will be appreciated that said operational parameters may change over time with or without the intervention of the controller 104. The process 400 may then proceed to act 404.

At act 404, the controller 104 receives at least some of the operational parameter data. In some examples, the controller 104 receives the operational parameter data from the SCS 112 or the 5G network 106. In some cases, the controller 104 may receive the operational parameter data directly from the airborne radar system 116, the environmental sensing system 114, the 5G bases stations 108, or the user devices 110. The process 400 may then proceed to act 406.

At act 406, the controller 104 parses and prepares the data received at act 404, including the operational parameter data. In some examples, the CLS 202 of the controller 104 will normalize the data, classify and characterize it, and parse it according to methods and systems described with respect to FIGS. 1-3. Once the data is fully parsed and prepared, the data may be used to generate soft decisions.

At act 408, the controller 104 generates soft decisions based on the data. In some examples, the CLS 202 will generate the soft decisions according to the methods and systems described with respect to FIGS. 1-3. The soft decisions generated by the controller 104 may indicate, for example, whether a radar is present, the location and/or trajectory of the radar, the likelihood of interference with the radar, and so forth. The soft decisions may also indicate which particular user devices 110 and/or base stations 108 are most likely to cause interference with the radar and/or cause the most interference, and so forth. Once the soft decisions are generated, the process 400 continues to act 410.

In an example embodiment, CLS 202 uses various 4G/5G or even Wi-Fi reference signals for detection of interference. Based on the features of the reference signals, the CLC 202 determines the presence of a Radar. Features may include Radar pulse repetition interval (PRI), pulse width (PW), frequency hopping parameters (FHP), modulation on pulse (MOP), and so forth. The reference signals may include downlink or uplink Demodulation Reference Signals (DMRS), sounding reference signals (SRS), primary synchronization sequence (PSS), secondary synchronization sequence (SSS), preamble, pilots, and so forth. The reference signals and/or reference signal features may, in some examples, be part of the spectrum data from the SCS 112 and/or the network data from the 5G network 106. In some examples, the reference signals may be stored in memory or otherwise available to the system 100. In some examples, the reference signals and/or reference signal features may be part of the algorithms used by the CLS 202 and/or may be stored in memory. In some examples, the reference signal features and/or reference signals may be preexisting signals, though in other examples they may not be preexisting and/or may be generated or created by the CLS 202 or other parts of the system 100.

At act 410, the controller determines and/or processes the soft decisions based on constraints. The constraints may be, for example, the constraints described with respect to FIGS. 1-3, in particular the constraints provided by the DE 306. The constraints, in general, may encourage certain outcomes based on the performance of the airborne radar system 116 and/or 5G network 106. For example, the constraints may encourage or bias the process 400 to operational parameters that favor performance in terms of one or more of IRRR, IRRC, TRR, TDRR, operational utility, or other metrics. The constraints may also favor one or more techniques for mitigating interference, for example, carrier aggregation and channel assignment (CA1), carrier aggregation (CA2), transit power control (TPC), beamforming and interference alignment (mMIMO-BM/IA/BM), adaptive modulation and coding (AMC), interference aware routing (IAR), handover, resource block sharing (RBS), and so forth. The constraints may be provided and determined by the DE 306 as described with respect to FIGS. 1-3. Once the constraints are generated, the constraints are applied to the soft decisions and/or the decision-making algorithm that receives the soft decisions and constraints, for example, the ECDE 308 of the controller 104. Once the constraints are determined and applied, the process 400 proceeds to act 412.

At act 412, the controller 104 determines whether a radar source, for example the airborne radar system 116, is present. In some examples, the controller 104 may determine whether a radar source is present by updating its belief in the true state of the SS system 100 based on the constraints and soft decisions provided it. Alternatively, in some examples, the controller 104 may treat the soft decision as indicative of the true state of the system. In some examples, the ECDE 308 makes the determination of whether a radar is present. In other examples, the CLS 202 may make the determination of whether a radar is present. If the controller 104 determines that a radar is present, the process 400 continues to act 416. If the controller 104 determines that no radar is present, the process 400 continues to act 422.

At act 416, the controller 104 determines whether interference with the radar by the 5G network is likely to occur and/or occurring. The interference determination may be made by the ECDE 308 in some examples or by the CLS 202 in some examples. The interference determination may be made based on the constraints, operational parameters or soft decisions. The controller 104 may determine which particular base stations 108, user devices 110, or other elements of the 5G network 106 are most likely to interfere with the radar (e.g., airborne radar system 116). However, it will be appreciated that the controller 104 does not need to identify particular base stations 108, user devices 110, or other elements of the 5G network 106. If the controller 104 determines that interference is likely, the process continues to act 418. If the controller 104 determines that interference is not likely, the process continues to act 422.

At act 418 the controller 104 selects or creates a mitigation strategy to mitigate interference by the 5G network 106 with the airborne radar system 116. Mitigation techniques include one or more of, for example, carrier aggregation and channel assignment (CA), transit power control (TPC), beamforming and interference alignment (mMIMO-BM/IA/BM), adaptive modulation and coding (AMC), interference aware routing (IAR), handover, resource block sharing (RBS), and so forth. The mitigation technique may be selected by the controller 104 based on machine learning algorithms and/or techniques including, for example, game theoretic techniques, deep reinforcement learning, deep convolutional neural networks, deep Q networks, and so forth. In some examples, the ECDE 308 may determine the appropriate mitigation techniques to apply. During this act, the controller 104 may generate a set of operational parameters to provide to the 5G network 106. Once the controller 104 selects or creates a mitigation strategy, the process 400 continues to act 420.

At act 420, the controller 104 determines whether the operational parameters of the 5G network 106 need to be adjusted to mitigate interference with the airborne radar system 116 in accordance with the technique selected during act 418. If the 5G network 106 is already configured appropriately—for example, configured to minimize interference in accordance with the selected technique, or the operational parameters are already set to whatever the controller 104 has determined would be appropriate, then the process 400 continues to act 422. Otherwise, the process 400 continues to act 424.

At act 422, the controller 104 maintains the 5G network 106 in the network's current state. No changes need be made to the 5G network 106 operational parameters, although the controller 104 may continue to monitor the 5G network 106.

At act 424, the controller 104 provides a signal to the 5G network 106 containing updated operational parameters and instructing the 5G network 106 to update the 5G network's 106 operational parameters. It will be appreciated that, because the controller 104 may have identified specific user devices 110 or base stations 108 to modify, that the new operational parameters may be applied to some or all of the 5G network 106, including some or all of the user devices 110 and/or base stations 108. In some examples, only a subset of base stations 108 or user devices 110 will be updated. In some examples, the entire 5G network 106 will be updated. It will also be appreciated that the operational parameters generated by the process 400 and applied need not be identical for every part of the 5G network 106. For example, a base station 108 may be instructed to alter its operational parameters in a different manner than another base station 108 or a user device, and a given user device 110 may be updated differently compared to other user devices 110 or base stations 108. For example, if a given channel is likely to interfere with the airborne radar system 116, only those user devices 110 and base stations 108 using that channel may be instructed to update their operational parameters to, for instance, switch communication traffic to a different channel.

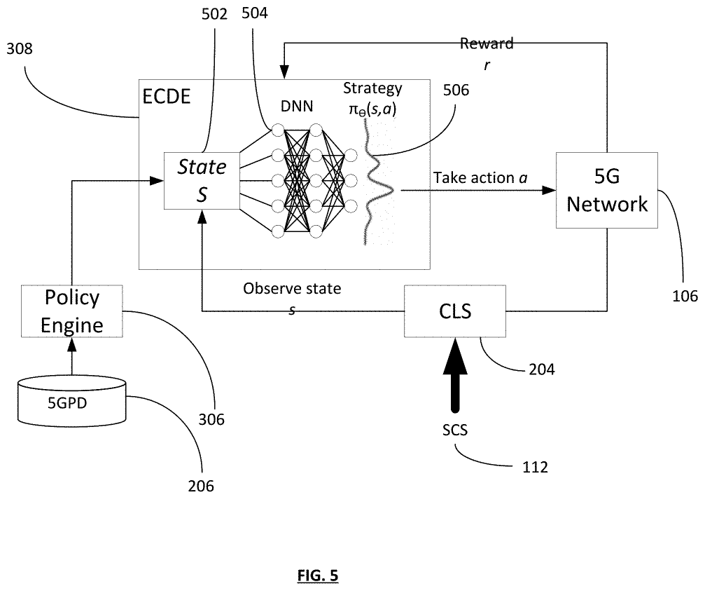

FIG. 5 illustrates a block diagram of logical and/or functional relationships of components described herein according to an example. As depicted, the ECDE 308 implements the deep Q learning technique to control, confirm, and modify the state S of the system 100 according to a chosen strategy 506.

The ECDE 308 may be configured to receive information about the observed state, S, of the 5G network 106 and the airborne radar system 116. Data may be provided or obtained from the 5G network 106 and/or the SCS 112. The state data may include any information or data related to the airborne radar system 116 and/or 5G network described herein, including location data, channel data, network operational parameters, frequency data, and so forth. The CLS 204 processes the data as described herein, for example, with respect to FIGS. 2-4. The CLS 204 then provides the state data to the ECDE 308. The ECDE 308 may be configured to maintain a state machine 502 of the state of the system, S, which may be updated based on the state data and any rewards provided to the ECDE 308, for example, reward r. The state machine 502 may also include constraints, such as any constraint described herein. The constraints may be provided by the policy engine 306 to the ECDE 308. The policy engine 306 may determine, at least in part, based on performance curves and other information contained in the 5G degrees of freedom database (5GPD) 206. The ECDE 308 provides the state data and constraints to a machine learning algorithm 504, which may be a deep neural network or other form of machine learning algorithm. The machine learning algorithm 504 processes the state information and constraint information to determine one or more appropriate interference mitigation strategies 506. Appropriate interference mitigation strategies 506 may include CA1, CA2, TPC, mMIMO-BM/IA/BM, AMC, IAR, handover, RBS, and so forth, including those strategies and techniques described with respect to FIG. 3. Once one or more appropriate mitigation strategies 506 are selected, the ECDE 308 may take an action, a. The action, a, may include setting operational parameters of the 5G network 106 or instructing the 5G network 106 to alter its operational parameters in accordance with the mitigation strategy 506 such that interference by the 5G network 106 with the airborne radar system 116 is mitigated, minimized or eliminated. The 5G network 106 may provide data indicative of changes in operation or in interference with the airborne radar system 116 indicative of the effectiveness of the selected mitigation strategy 506, which may be processed by the ECDE 308 as reward information, r. Reward information r may be used by the ECDE 308 to determine any future alterations to the state machine 502 and therefore to the configuration of the 5G network 106 and the 5G network's 106 operational parameters. In some examples, the future alterations will be determined using the machine learning algorithm 504 wherein the machine learning algorithm 504 takes into account the reward, r.

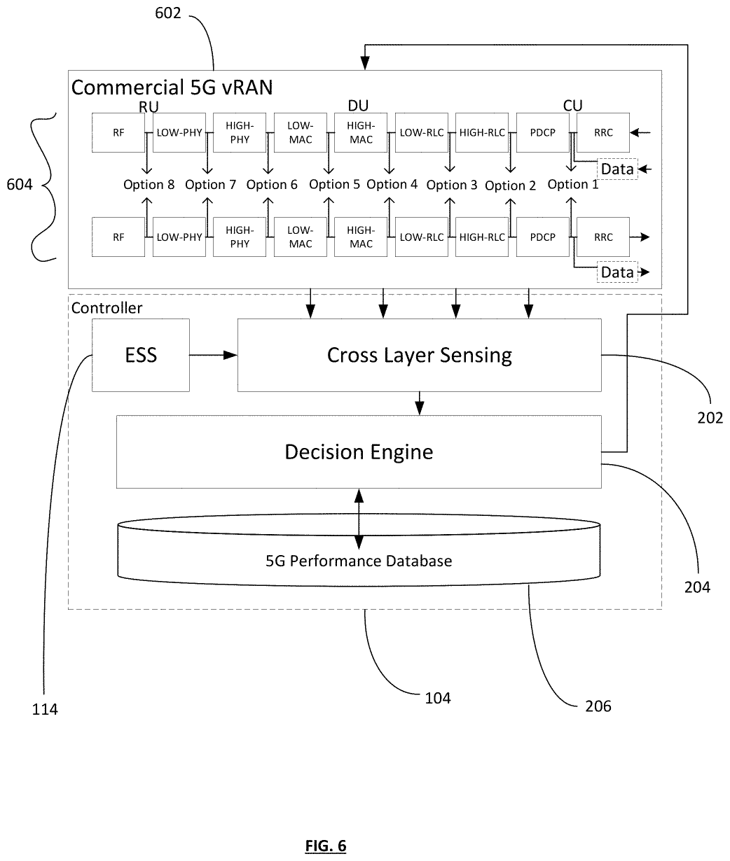

FIG. 6 illustrates a 5G network 106 implemented as a virtual Radio Access Network (vRAN) 602 according to an example. The CLS 202, decision engine 204, 5G performance database 206, and ESS 114 provide functionality to the vRAN 602 to render the vRAN “cognitive.” In this context, “cognitive” means the vRAN is provided with wide-band RF and PHY/MAC/NET (cross layer) sensing, and a decision engine to detect, characterize and mitigate interference. In some examples, the vRAN is provided with all the functionality available to the controller 104. The vRAN network may be based on Open Radio Access Network (ORAN) specifications.

The vRAN 602 may include various operational parameters 604 that may be related to configurable options (option 1 through 8) and/or which may be individually configurable. The various operational parameters 602 include parameters related to the radio resource control (RRC) layer, the packet data convergence protocol (PDCP), the high and low radio control link (RCL) layers, the high and low MAC, NET, and PHY layers, and the radio frequency (RF) parameters.

It will also be appreciated that the ESS 114 need not be coupled to the SCS 112. In some examples, the ESS 114 (or its functionality) may be directly available to or incorporated into the controller 104. It will be appreciated that the foregoing applies to other examples described herein as well.

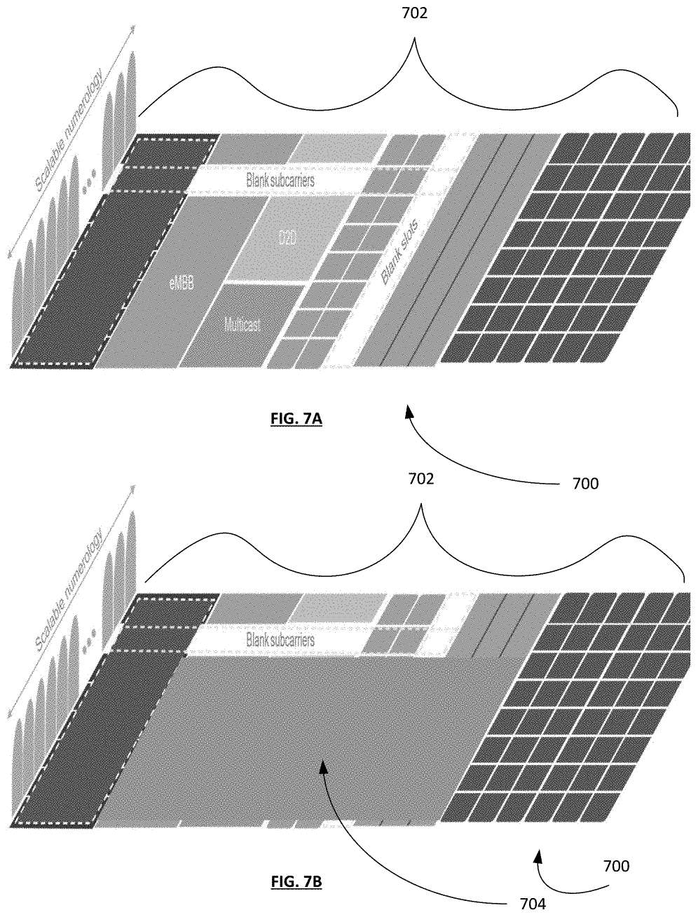

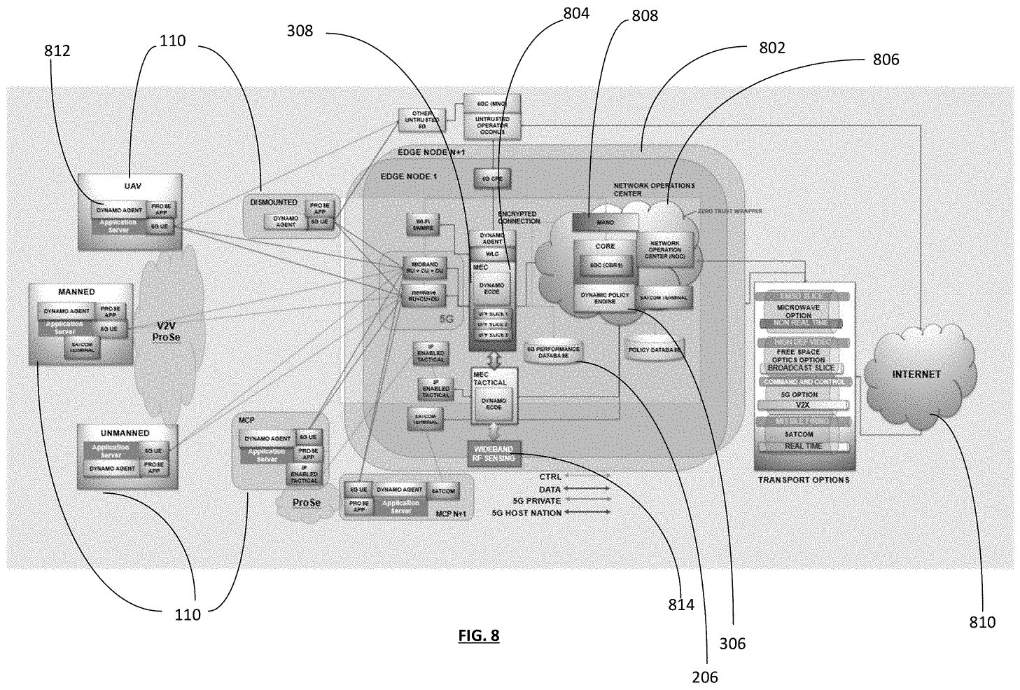

FIGS. 7A and 7B shows an example embodiment of sharing of the resource blocks of a 4G/5G system 700 with the radar (e.g., the airborne radar system 116).

FIG. 7A depicts a 4G/5G system 700 that is not sharing any resources with a radar. The various available resource blocks 702, for example, the enhanced mobile broadband (eMBB) block, the multicast block, and the device-to-device (D2D) block, and various other resource blocks 702 are fully available to the 5G network 106, including base stations 108 and user devices 110. It will be appreciated that a resource block is the smallest unit of resources that can be allocated to a user. In the case of 5G, in some examples, the resource block is 180 kHz wide in frequency and 1 slot long in time. The scalable numerology may be the 5G numerology, which is well-defined and discussed elsewhere.

FIG. 7B depicts a 4G/5G system 700 wherein various resource blocks 702 have been allocated to a radar system, for example the airborne radar system 116. The radar allocated resource blocks 704 include resource blocks previously available for multicast, eMBB, D2D, and so forth. When the resource blocks 700 are allocated to the radar, they become unavailable to the 5G network 106 for use. For example, base stations 108 and user devices 110 may not use the radar allocated resource blocks 704. In this manner, resource blocks 700 may be provided to a radar system for use to mitigate interference between the radar and the 5G network 106. This technique may be referred to as resource block sharing (RBS), which has been previously mentioned herein.

In some examples, the controller 104 may control or instruct the 5G network 106 to perform RBS. RBS may be a mitigation strategy selected by the ECDE 308, as described herein.

FIG. 8 illustrates a detailed commercial communications system architecture 800 according to an example. The architecture 800 may, in some examples, be applicable for commercial and/or military use cases. The architecture 800 includes one or more edge nodes 802, an internet 810, and various user devices 110. The user devices 110 may include many different types of user device, including dismounted user devices, mobile control points, unmanned aerial vehicles, unmanned devices, manned devices, and other devices, for example, cellphones, computers, laptops, tablets, and so forth. User devices may include an agent 812. The one or more edge nodes 812 may includes multi-access edge compute 804, ECDE 308, base stations 108 (or connectivity to base stations 108) of the 5G network 106, SCS 112, cloud infrastructure 806, Management and Network Orchestration (MANO) 808, the policy engine 306, and the 5G performance database 206.

The user devices 110 are communicatively coupled to the one or more edge nodes 802. In some examples, the user devices 110 are communicatively coupled to the one or more edge nodes 802 via the base stations 108. The MEC 804 may contain the ECDE 308, and the ECDE 308 may be communicatively coupled, via the MEC 804 or directly, with the base stations 108, wideband RF sensing 814, cloud infrastructure 806, including the policy engine 306, and performance database 206. The MANO 808 and policy engine 306 may reside in the cloud infrastructure 806. The policy engine 306 and MANO 808 may be coupled together. The internet 810 may be communicatively coupled to the user devices 110 and/or the edge node 802. In some examples, each element of the architecture 800 may communicate with any other element of the architecture 800 using 5G communications technology, satellite communications, Wi-Fi communications, or any other form of communications, wireless or wired. The wideband RF sensing 814 may provide spectrum data or any other data related to communications transmissions and radar signals. In some examples, the wideband RF sensing 814 may also provide and/or detect any data the SCS 112 can provide or detect.

In the architecture 800, the controller 104 may be applied to 5G, Wi-Fi, and satellite communications or non-terrestrial communications. The architecture 800 may consist of an edge network including 5G, Wi-Fi, and satellite base communications. The architecture 800 may support a wide variety of applications, including Augmented Reality/Virtual Reality, Remote Surgery, Real-time Video, and/or Internet of Medical Things (IoMT). The architecture 800 may also be used to support military applications, for example, at a command post, or with unmanned aerial systems (UASs), unmanned aerial vehicles (UAVs), other manned and unmanned platforms, warfighters, and so forth. The military network may operate in host nations or regions where the existing 4G and/or 5G network is not trusted.

The agent 812 may be part of the controller 104 or may be designed to work with the controller 104. In some examples, the agent 812 may be an application installed or residing on a user device 110 or base station 108. The agent 812 may work in tandem with the controller 104 to manage interference with the airborne radar system 116. The agent 812 may be capable of performing any function the controller 104 may perform, and may receive instructions from the controller 104 and implement those instructions on a given user device 110. For example, the agent 812 may receive, from the ECDE 308, operational parameters or instructions instructing the agent 812 to modify operational parameters of the user device 110 the agent 812 is installed on. The agent 812 may then alter the operational parameters of the user device 110 it is installed on in accordance with the instructions and/or operational parameters transmitted by the ECDE 308. The agent 812 and controller 104 may therefore provide desired levels of quality of service for the airborne radar system 116 and 5G network 106.

The controller 104 and agents 812 provide resilient communications with multiple pathways to improve security of data transmissions as well as to provide assurance that information will be delivered over a heterogeneous communications network consisting of multiple types of communications capability, including 5G, Wi-Fi, military communications radios, satellite communications, optical fiber communications, and so forth. The controller 104 and agents 812 provide secure and reliable communications in multiple environments, including austere, permissive, and non-permissive environments with or without secure network connectivity.

The controller 104 and agent 812 may also orchestrate network slices. Network slicing is a network architecture that enables the multiplexing of virtualized and independent logical and/or virtual networks on the same physical network infrastructure. Each network slice is an isolated, end-to-end network tailored to fulfil diverse requirements requested by a particular application.

The controller 104 and agent 812 enable resilient communications to ensure interference mitigation via creation of high resiliency network slices over multiple paths and transports. Such high resiliency slices may be formed over trusted networks (such military trusted networks such as tactical radios, military MEC, and military transport) as well as untrusted networks (such as commercial 5G, commercial and noncommercial satellite communications (SATCOM), and so forth). The agent 812 and controller 114 provide mitigation against link failures and enable reliable 5G communications between devices independent of, or in concert with, established telecommunication infrastructures. The agent 812 and controller 104 can provide robust command and control functionality in this manner.

The controller 104 and/or agent 812 interact with the 5G network's 106 core interface, as well as MEC and ORAN compliant vRAN supporting, for example, eMBB, massive machine type communications, ultra reliable low latency communications, and so forth. The one or more edge nodes 802 may use Wi-Fi, cellular, private and enterprise networks, SATCOM, and so forth, and may include infrastructure both physical and virtual consisting of one or more of 5G core network components, derivatives, virtual services, functions, software, and human interface hardware. The MANO 806 may coordinate the management and virtualization of the aforementioned functions and infrastructure resources for various purposes, including to ensure the various user devices 110 remain connected to the edge nodes 802. The network slicing functions delineate the mapping between logical/virtual resources and physical resources.

It will be appreciated that, in the foregoing example of architecture 800, the controller 104 may be distributed, and may reside on one or more of the MEC 804, cloud infrastructure 806, one or more edge nodes 802, or elsewhere. The one or more agents 812 may reside on respective user devices 110. The policy engine 306 and MANO 808 may reside in the cloud infrastructure 806. The network slicing decisions may be made using thousands of measurements locally and across the network, and may include measurements of RF/PHY/MAC and NET characteristics, which may be measured in the form of large-scale feature matrices. The feature matrices and/or RF/PHY/MAC/NET characteristics may be provided to a machine learning engine, for example, the policy engine 306 and/or EDCE 308, which make optimization decisions to mitigate interference based on techniques such as deep convolutional neural networks and deep reinforcement learning. The controller 104 may provide a cross-layer view of all the environments for all available network connections between sites. The controller 104 and agent 812 may interact with the MEC 804, 5G core, and MANO 808 functions to initiate and terminate various types of network slices which make decisions, such as which packet needs to be forwarded over which channel, both locally and globally. The controller 104 and/or agent 812 may also allow the architecture 800 to compartmentalize the various data streams to keep the data streams out of reach (i.e., inaccessible) to systems, people, and devices that do not need to receive the data streams. The controller 104 and agent 812 can thus provide a service based architecture and service level agreements of the 5G network 106. To ensure the appropriate level of security, zero trust data protection may be integrated into the MEC nodes at all edge nodes 802 and other sites. The zero trust model ensures that data can only be accessed by authenticated and authorized users.

In some examples, the agent 812 may reside on the user device 110 and makes a decision on what mode of transport should be used to avoid interference. In some examples, if a radar is present on the same channel as the user device 110 the agent 812 is installed on, the agent 812 may decide to forward all the traffic using Wi-Fi or satellite (e. g. non terrestrial network (NTN)) communications capability.

In another embodiment, the controller 104 makes a decision on what mode of transport should be used by the 5G system to avoid interference. For example, if a radar is present on the same channel as a part of the 5G network 106, the controller 104 may ask all the user devices 110 using the same channel to either use Wi-Fi or satellite communications (NTN) capability. In case one or more of the user devices 110 do not have the capability to use Wi-Fi or satellite communications, the controller 104 may ask the base stations 108 to stop transmitting on that channel.

In another embodiment, controller 104 may ask the base stations 108 to selectively reduce the base station 108 power or turn off base station 108 transmission in certain directions. The controller 104 may ask all user devices 108 that may be impacted by the controller's 104 requests to the base stations 108 to connect with an alternate base station 108. In some examples, switching from one base station 108 to another 108 by a user device 110 is an example of handover.

In another embodiment, the controller 104 may ask the base stations 108 to allocate some of the base station 108 resource blocks to be used by the radar, while blocks not allocated to the radar may remain available to be used for communications, such as communications by user devices 110 or base stations 108.

Various controllers, such as the controller 104, may execute various operations discussed above. Using data stored in associated memory and/or storage, the controller 104 also executes one or more instructions stored on one or more non-transitory computer-readable media, which the controller 104 may include and/or be coupled to, that may result in manipulated data. In some examples, the controller 104 may include one or more processors or other types of controllers. In one example, the controller 104 is or includes at least one processor. In another example, the controller 104 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A system for spectrum sharing comprising:
at least one controller configured to receive first data pertaining to a first system, and send to and receive second data from a second system, the first system and second system configured to use at least part of a same spectrum, the at least one controller being further configured to:
based at least in part on the first data, determine that the first system is using at least part of the same spectrum;
based at least in part of the second data, determine that the first system is likely to be interfered with by the second system; and
provide instructions instructing the second system to modify one or more operational parameters of the second system to reduce interference with the first system.

2. The system of claim 1, wherein the first system is a radar and the second system is a 5G network.

3. The system of claim 1, wherein the first data is reference signal data and the second data is network data.

4. The system of claim 1, further comprising a sharing and coexistence system configured to detect the presence of the first system and to provide the first data to the at least one controller.

5. The system of claim 4, further comprising:
a cross layer sensing block communicatively coupled to the second system and the sharing and coexistence system and configured to generate one or more decisions;
a decision engine communicatively coupled to the cross layer sensing block and the second system and configured to determine one or more operational parameters; and
a performance database communicatively coupled to the decision engine and configured to provide performance curves to the decision engine.

6. The system of claim 5, wherein the cross layer sensing block further comprises a feature extraction and normalization block communicatively coupled to an environmental characterization and pattern classification block, the feature extraction and normalization block being configured to process data received from the cross layer sensing block, and the environmental characterization and pattern classification block being configured to generate the one or more decisions; and
wherein the decision engine further comprises an edge compute decision engine configured to determine the operational parameters and a policy engine configured to provide policies to the edge compute decision engine.

7. The system of claim 6, wherein the policy engine further comprises a dynamic games module.

8. The system of claim 5, wherein the cross layer sensing block is further configured to process the first data and the second data.

9. The system of claim 8, wherein the cross layer sensing block is further configured to generate the one or more decisions responsive to processing the second data.

10. The system of claim 5, wherein the one or more decisions include a probability that the first system is present.

11. The system of claim 5, wherein the one or more decisions are determined using a partially observable Markov decision process.

12. The system of claim 5, wherein the one or more decisions are determined based on at least one of a pulse repetition interval, a pulse width, and a modulation on a pulse of a signal originating from the first system.

13. The system of claim 5, wherein the one or more decisions include an estimate of at least one base station or user device which is likely to cause interference with the first system.

14. The system of claim 5, wherein the cross layer sensing block is further configured to provide the one or more decisions to the decision engine, and the decision engine is further configured to determine the one or more operational parameters for the second system based on the one or more decisions to mitigate interference of the second system with the first system.

15. The system of claim 14, wherein the decision engine is further configured to determine the one or more operational parameters based on one or more policies.

16. The system of claim 15, wherein the performance database is further configured to provide one or more performance curves based on Swerling models to the decision engine, and the decision engine is configured to use the one or more performance curves to determine the one or more operational parameters.

17. The system of claim 1, wherein the first data is provided by an incumbent informing capability.

18. The system of claim 17, wherein the incumbent informing capability provides information to the at least one controller indicating that the first system is present.

19. The system of claim 1, wherein determining that the radar is present includes:
the at least one controller being configured to calculate a probability that the radar is present based at least in part on the spectrum data; and
the at least one controller being configured to determine that the probability that the radar is present is greater than a threshold value.

20. The system of claim 1, wherein the first data includes location data indicative of a location of the first system and/or includes the channel data including information indicating which channels may cause interference and/or which channels are available for use.

21.-54. (canceled)
